(19) United States
(12) Patent Application Publication
(10) Pub. No.: US 2002/0133591 A1
(43) Pub. Date: Sep. 19, 2002

(54) Method and apparatus for mapping of attributes to networked resources

(76) Inventors: Selene K. Makarios, Mountain View, CA (US); Robert C. Fitzwilson, Atherton, CA (US)

Correspondence Address: SKJERVEN MORRILL LLP, THREE EMBARCADERO CENTER, 28TH FLOOR, SAN FRANCISCO, CA, 94111, US

(21) Appl. No.: 09/809,603

(22) Filed: Mar. 14, 2001

(51) Int. Cl. G06F 9/00; G06F 15/173

(52) U.S. Cl. 709/225; 709/105

(57) ABSTRACT

An embodiment of the present invention provides an attribute service for computer networks. The attribute service establishes a network database that relates attributes to computer resources. The attributes included in the database are typically part of a predefined or codified set. Client computers form queries using attributes selected from the codified set. The client computers then send the queries to a server that provides the attribute service (an AS server). The AS server resolves the queries using the database. The AS server formulates a response for each query and sends it to the requesting client computer. This provides an attribute-oriented method for identifying and locating resources within computer networks.

### TECHNICAL FIELD OF THE INVENTION

The present invention is generally related to systems for identifying and locating resources within computer networks. More specifically, the present invention provides a service that maps attributes to resources. The attribute-based system enhances the ability of users to locate resources based on logical content.

### BACKGROUND OF THE INVENTION

Computer users (human ones, at least) typically rely on alphanumeric names to identify computers and other network resources. Domain names and uniform resource locators are two examples of alphanumeric names of this type. Computers, on the other hand, generally rely numeric addresses. Internet protocol (IP) addresses (e.g., 198.105.232.4) are an example of one type of numeric address.

Computer networks accommodate the use of alphanumeric names alongside numeric addresses by providing various conversion protocols and services. One of these protocols is the Domain Name Service or DNS. DNS translates domain names and URLs into equivalent IP addresses. The DNS system is, in fact, its own network. If one DNS server doesn't know how to translate a particular domain name, it asks another one, and so on, until the correct IP address is returned.

The simultaneous use of these two systems (i.e., numeric and human readable) has known advantages. Perhaps the most important of these is the fact that alphanumeric names are much easier for human users to remember and use than numeric addresses. At the same time, it is clear that even this bifurcated system has a number of disadvantages. One of these disadvantages stems from the fact that the alphanumeric names chosen for computer systems tend to be highly arbitrary. For example, it is not uncommon for a company to name its computers after characters on television programs or brands of beer. These names are easy for human users to understand but include little to no information about the computer systems themselves. URLs tend to be similarly arbitrary. This makes names, including URLs, of little use to a user who is searching for a particular resource within a computer network.

Within the World Wide Web the problem of arbitrary URLs has been partially overcome by the development of a number of search engines. Typically, these search engines allow a user to enter a set of keywords identifying the information they are seeking. A set of URLs are returned which the user may then use to access web pages in the hope of obtaining the desired information.

Unfortunately, there can be little assurance that the set of keywords entered by the user will actually find a web page of interest. Even where a potentially useful web page is located, it may be buried within a list of other less relevant pages. The user may be forced to sort through these pages or reformulate the original search using a new set of keywords.

For reasons such as these, it is clear that there is a need to develop alternate methods for identifying and locating computer systems and other resources within computer networks. This need is particularly relevant to networks like the Internet and World Wide Web where large numbers of resources and computer systems are involved.

### SUMMARY OF THE INVENTION

An embodiment of the present invention provides an attribute service for computer networks. The attribute service establishes a network database that relates attributes to computer resources. The attributes included in the database are typically part of a predefined or codified set. Client computers form queries using attributes selected from the codified set. The client computers then send the queries to a server that provides the attribute service (an AS server). The AS server resolves the queries using the database.

The AS server then formulates a response for each query. For some embodiments, this means that the AS server finds zero or more matching alphanumeric names (such as URLs) that match each query. In other cases, the AS server will take the further step of resolving the alphanumeric names to equivalent numeric addresses. The AS server may perform this step internally or with the help of a DNS server. The AS server then sends each response to the requesting client computer.

In this way, the present invention provides a method that allows resources in a computer network to be cataloged according to their attributes. Users can search the catalog (using the AS server) to find resources that match their needs.

Other aspects and advantages of the present invention will become apparent from the following descriptions and accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 is a block diagram of an Internet-like network shown as a representative environment for deployment of the present invention.

FIG. 2 is a block diagram of a computer system as used within the network of FIG. 1.

FIG. 3 is a flowchart showing the steps associated with an embodiment of the attribute-based lookup service method of the present invention.

### DETAILED DESCRIPTION OF THE PREFERRED EMBODIMENTS

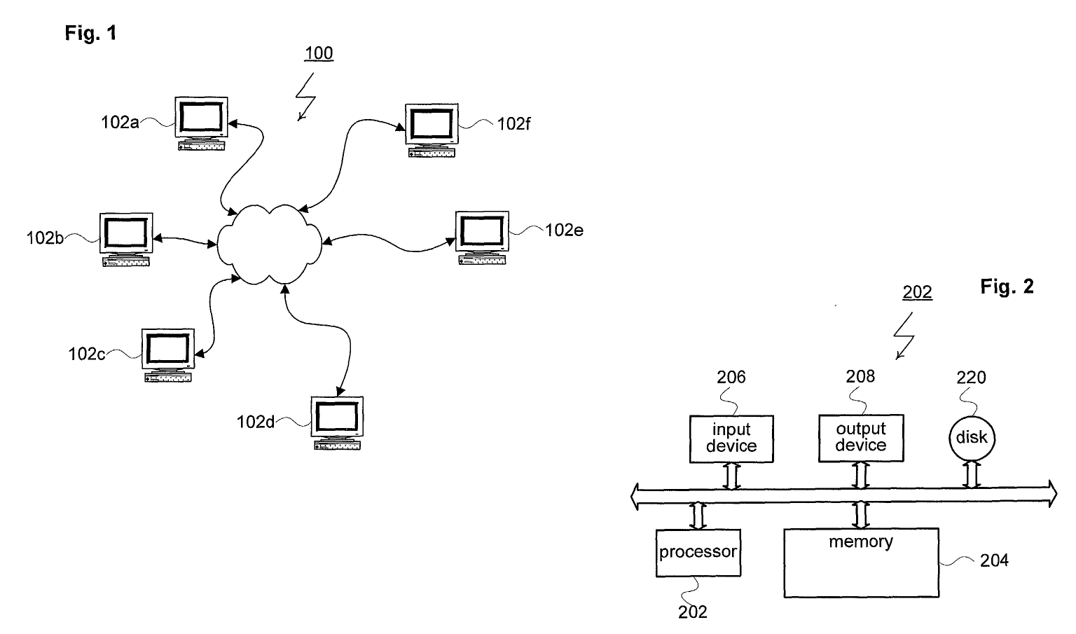

The preferred embodiments of the present invention and their advantages are best understood by referring to FIGS. 1 through 3 of the drawings. Like numerals are used for like and corresponding parts of the various drawings.

In FIG. 1, a computer network 100 is shown as a representative environment for an embodiment of the present invention. Computer network 100 is intended to be representative of the complete spectrum of computer network types including Internet and internet-like networks. Computer network 100 includes a number of computers, of which computers 102a through 102f are representative. Computers 102 are intended to be representative of the wide range of large and small computer systems that are used in computer networks of all types.

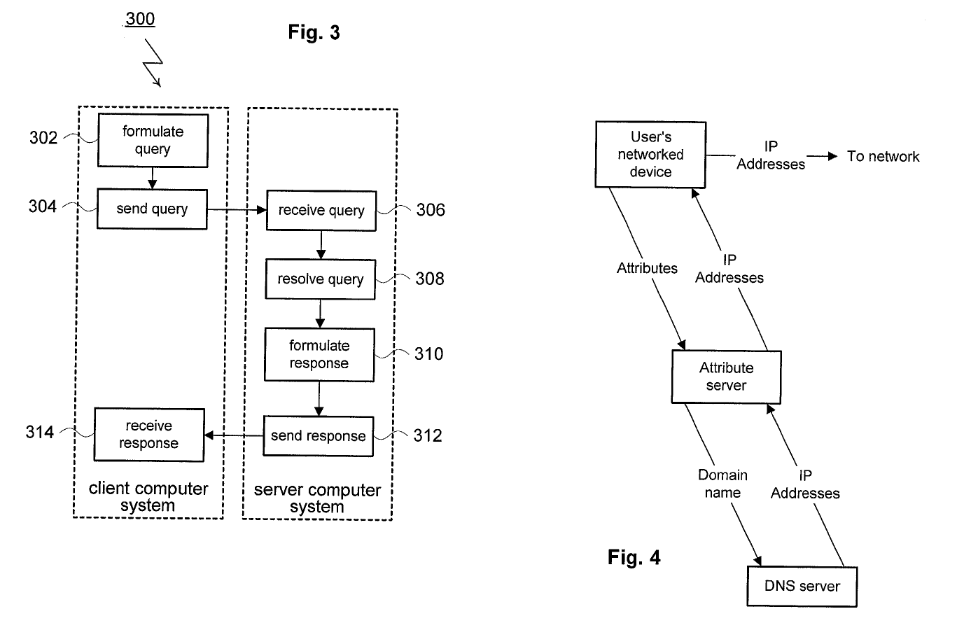

FIG. 2 shows a representative implementation for computers 102. Structurally, each computer 102 includes a processor, or processors 202, and a memory 204. Processor 202 can be selected from a wide range of commercially available or custom types. An input device 206 and an output device 208 are connected to processor 202 and memory 204. Input device 206 and output device 208 represent all types of I/O devices such as disk drives, keyboards, modems, network adapters, printers and displays. Each computer 102 may also includes a disk drive 210 of any suitable disk drive type (equivalently, disk drive 210 may be any nonvolatile mass storage system such as “flash” memory).

Within network 100, one or more computers 102 act as servers for an attribute service (AS). The attribute service includes a networked database that relates computer resources (such as computers 102, printers, web pages, or other resources) to attributes. The computers 102 that provide the attribute service may be organized in a number of different configurations. For one of these configurations, a single computer 102 acts as the server for the attribute service and networked database. For another configuration, one more computers 102 are configured in a fault-tolerant fashion to provide fail-over protection for the attribute service. Computer 102 may also provide the attribute service in parallel to provide another type of fault-tolerance and load balancing. In yet another configuration, one or more computers 102 are configured to provide the attribute service in a hierarchical fashion. For this type of configuration, individual AS servers are assigned domains with network 100. Each individual AS server provides the attribute service within its domain. Cross-domain requests are handled by consultation between AS servers.

The network database provided by the attribute service relates computer resources to attributes. For the described embodiment, the attributes included in the network database are part of a predefined or codified set. The process of defining these resources may be informal or formal. In some cases, an organization or agency may be vested with the authority to define the attribute set. This could function in much the same was as the current Internic organization handles the distribution of domain names within the Internet.

The attribute service provides an attribute-based lookup service within network 100. Computer 100 use the lookup service to locate resources based on the attributes of those resources. A representative sequence of steps associated with a lookup of this type is shown as Method 300 of FIG. 3. Method 300 begins with step 302 where one of computers 102 formulates a query for the attribute service. In many cases, this step is performed as a direct result of user interaction with computer 102. Thus, step 302 might be performed as part of a response to a web-searching request. In other cases, step 302 may be performed as part of less-interactive applications. To formulate the query of step 302, computer 102 selects one or more attributes from the predefined set of attributes. These attributes may be combined with each other using various logical operations and wildcards. In general, larger numbers of attributes are associated with greater specificity and no combination of attributes is guaranteed to have a non-null set of corresponding resources.

In step 304, computer 102 sends the query to the attribute service. In general, there is a range of methods available for transmitting the query. For some embodiments, computer 102 will know which computer 102 is acting as the AS server. Computer 102 may have, for example, a list of computers 102 that act as AS servers and may use that list to address the query. Use of a list also allows computers 102 to attempt to use alternate AS servers in cases where a primary AS server fails to respond. For other embodiments, computers 102 may contact the AS server by broadcasting a message within network 100. This allows computers 102 to contact the AS server without knowing its specific identity.

In step 306, the AS server receives the query sent in step 304. In step 308, the AS server resolves the just received query. In general terms, this means that the AS server maps the attributes included in the query to one or more resources included in network 100. The resources may be computers 102, printers, network disks, web pages, other networks or any other object that may be addressed in computer networks. The AS server maps the attributes included in the query to resources using the network database. It should be noted that the mapping is not exclusive. This means that a set of attributes may map to one or many resources. It should also be noted that individual resources may be associated with multiple attributes and attribute sets.

In step 310, the AS server formulates a response. The response includes the resources identified in the previous step. For some embodiments, these resources are included as alphanumeric names (such as URLs). In other cases, the AS server will take the further step of resolving the alphanumeric names to equivalent numeric addresses. The AS server may perform the step of resolving alphanumeric names to equivalent numeric addresses internally. This means that the AS server would include its own internal database mapping alphanumeric names to equivalent numeric addresses. As shown in FIG. 4, the AS server may also resolve alphanumeric names using a DNS server.

In step 312, the AS server sends the response to the requesting computer 102. The requesting computer 102 receives the request in step 314.

The possibly subjective nature of the assignment of attributes to resources indicates that there is likely no single and authoritative Attribute Service, with a few possible exceptions such as some Attribute Service based entirely upon weights and measures subject to international standardization. Thus there is a market for subjective Attribute Service authorities based on perceived authority.

In certain embodiments, networked resources are retrieved based on their codified attributes, but with each user acting as their own Attribute Service. Thus subjective attributes are resolved locally based on a model of that user's perspective and interests.

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

What is claimed is:

1. A method for locating resources within a computer network, the method comprising the steps of:
a) formulating, by a client computer, a query, the query including one or more attributes;
b) sending, by the client computer, the query to a server computer;
c) formulating, by the server computer, a response, the response including zero or more resources identified by the attributes in the query; and
d) sending, by the server computer, the response to the client computer.

2. A method as recited in claim 1 wherein step c further comprises the step of mapping, by the server computer, the attributes in the query to one or more resources within the computer network.

3. A method as recited in claim 2 wherein the step of mapping further comprises the step of searching a network database containing mappings between attributes and resources.

4. A method as recited in claim 1 wherein the response includes zero or more alphanumeric strings associated with the resources identified by the attributes in the query.

5. A method as recited in claim 1 wherein the response includes zero or more numeric addresses associated with the resources identified by the attributes in the query.

6. A method as recited in claim 5 wherein step c further comprises the step of translating alphanumeric strings associated with the resources to equivalent numeric addresses.

7. A method as recited in claim 6 wherein the server computer performs the translating step using a DNS lookup.

8. A data storage medium having machine-readable code stored thereon, the machine-readable code comprising instructions executable by an array of logic elements, the instructions defining a method comprising the steps of:
a) formulating, by a client computer, a query, the query including one or more attributes;
b) sending, by the client computer, the query to a server computer;
c) formulating, by the server computer, a response, the response including zero or more resources identified by the attributes in the query; and
d) sending, by the server computer, the response to the client computer.

9. A data storage medium as recited in claim 8 wherein step c further comprises the step of mapping, by the server computer, the attributes in the query to one or more resources within the computer network.

10. A data storage medium as recited in claim 2 wherein the step of mapping further comprises the step of searching a network database containing mappings between attributes and resources.

11. A data storage medium as recited in claim 8 wherein the response includes zero or more alphanumeric strings associated with the resources identified by the attributes in the query.

12. A data storage medium as recited in claim 1 wherein the response includes zero or more numeric addresses associated with the resources identified by the attributes in the query.

13. A data storage medium as recited in claim 5 wherein step c further comprises the step of translating alphanumeric strings associated with the resources to equivalent numeric addresses.

14. A data storage medium as recited in claim 6 wherein the server computer performs the translating step using a DNS lookup.
